(19) United States
(12) Patent Application Publication
(10) Pub. No.: US 2013/0006986 A1
(43) Pub. Date: Jan. 3, 2013

(54) Automatic Classification of Electronic Content Into Projects

(75) Inventors: Tu Huy Phan, Redmond, WA (US); Shiun-Zu Kuo, Bothell, WA (US); Nicholas Caldwell, Bellevue, WA (US); Saliha Azzam, Redmond, WA (US)

(73) Assignee: MICROSOFT CORPORATION, Redmond, WA (US)

(21) Appl. No.: 13/170,544

(22) Filed: Jun. 28, 2011

(51) Int. Cl. G06F 17/30

(52) U.S. Cl. 707/737; 707/E17.046

(57) ABSTRACT

Automatically classifying content into a given project workspace is provided. New electronic mail items, documents, meeting requests, tasks, calendar items, and the like are automatically classified into a project workspace. Thus, a user is not required to engage in a time-consuming task of identifying, collecting, and associating such content with a given project workspace. In addition, feedback may be provided to the user on the quality of automatic assignments of content items to the desired workspace for editing content associated with the desired workspace and for improving the automatic classification process.

### BACKGROUND

Within any number of business, social, or academic enterprises, a given person may be a member of several project teams. In such cases, it may become difficult for the person to track which of their electronic content (e.g., electronic mail communications, electronic tasks, electronic meeting notations, calendaring items, instant messaging communication threads, etc.) belongs to each of the different project teams. For example, a given employee of a business enterprise may belong to a first project team associated with software development for a first software product line, and the person may belong to a second project team associated with software development associated with a second product line. This may be particularly problematic when the volume of content is high, such as may be the case with large databases of files or busy electronic mail or instant messaging inboxes. In any given day, the person may receive tens or even hundreds of electronic mail messages, documents, instant messaging communication threads, tasks, meeting notices, and the like associated with each of the different project teams. In these cases, the user may become frustrated and may simply give up on attempting to keep content organized in association with the different project teams.

It is with respect to these and other considerations that the present invention has been made.

### SUMMARY

Embodiments of the present invention solve the above and other problems by automatically classifying content as associated with a given electronic workspace. New electronic mail items, documents, meeting requests, tasks, calendar items, and the like are automatically classified into a project space. Thus, a user is not required to engage in a time-consuming task of identifying, collecting, and associating such content with a given project workspace. In addition, feedback may be provided to the user on the quality of automatic assignments of content items to the desired workspace for editing content associated with the desired workspace and for improving the automatic classification process.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a screen shot of a software application user interface showing a content classification notification.

FIG. 2 is a simplified block diagram illustrating an association between a number of electronic content repositories and one or more electronic project workspaces via a project classification system.

FIG. 3 illustrates a system architecture and process flow associated with automatically classifying electronic content into one or more electronic project workspaces.

FIG. 4 illustrates a system architecture and process flow associated with utilizing classifications of electronic content.

FIG. 5 is a block diagram of a system including a computing device with which embodiments of the invention may be practiced.

### DETAILED DESCRIPTION

As briefly described above, embodiments of the present invention are directed to automatically classifying documents into one or more project workspaces. Newly created content, for example, documents, electronic mail messages, text messages, meeting requests, tasks, and the like are analyzed, and a suggested project classification is provided to a user associated with the new content. The user is allowed through a user interface component to accept or reject the project classification or to propose a different project classification. Based on the user's feedback, the classification system learns, and the classification process is improved.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

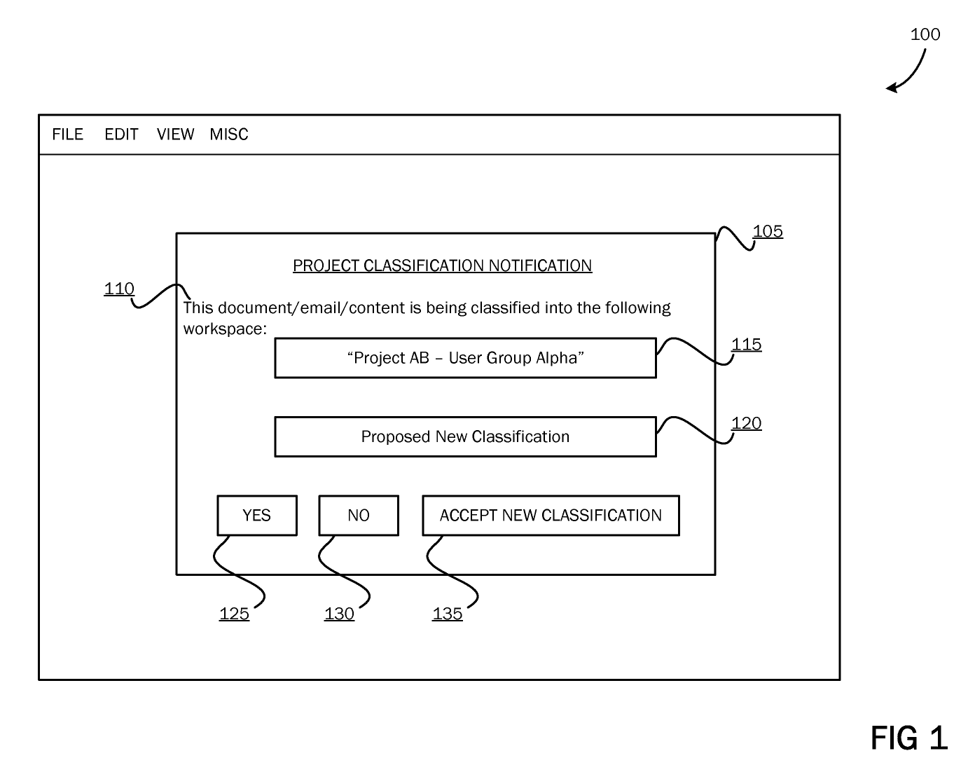

FIG. 1 illustrates a screen shot of a software application user interface showing a content classification notification. As briefly described above, as new content, for example, electronic mail items, documents, text message items, meeting requests, task items and the like are generated and stored, an automatic content classification system of the present invention utilizes information about the newly generated and stored content along with information about various project workspaces and content classified therein to suggest a classification of the newly generated and stored content into a new or existing project workspace. For example, if a user generates a spreadsheet document containing third quarter sales figures associated with a sales operation for his/her employer, when the user saves the newly generated spreadsheet, information about the spreadsheet document may be used to compare with information contained in other content that has been classified as belonging to one or more other project workspaces. Once a proposed classification for the newly generated and stored content has been made, the user may be presented with a visual user interface component to notify the user that the newly generated and stored content has been recommended for classification into a specific project workspace or that the newly generated content is recommended for classification into a new project workspace.

Referring to FIG. 1, a user interface component 100 is illustrative of any user interface component in which a content classification notification may be made. For example, the user interface component 100 may be illustrative of an electronic mail user interface, a task application user interface, a text messaging application user interface, an Internet-based discussion forum user interface, and the like. That is, the user interface component 100 is illustrative of any user interface component in which a notification of the recommended classification of a content item into a given project workspace may be made and with which user input may be received.

The user interface component 100 includes an example header 105 of “Project Classification Notification” to indicate to the user that a content item just generated and stored has been classified as will follow in the user interface presentation. As should be appreciated, the classification of content may occur at various times in the life cycle of a particular content item. For example, the classification and subsequent classification notification to the user may occur when the user generates and saves a content item, or the classification and notification may occur when a content item is revised and saved, or when a user receives a new content item, for example, a meeting request, an electronic mail item, a text message item, and the like.

Referring still to FIG. 1, a statement 110 of the classification of the subject content is provided to the user. For example, as illustrated in FIG. 1 a statement such as “This document/email/content is being classified into the following workspace:” may be provided above a text box or field 115 in which an indication of the particular project workspace to which the content is classified may be displayed. For example, in the text box or field 115 illustrated in FIG. 1, a project indication of “Project AB—User Group Alpha” is displayed to indicate to the user that project workspace to which the subject content is being classified. As should be understood, classification of content into a particular project workspace may mean that the content is linked to the project workspace via a path, may mean that the content is associated with the project workspace by applying metadata to the classified content in association with the subject workspace, or may mean that the content is actually stored in a memory location with other content classified under the same project workspace. Similarly, if the project workspace being recommended to the user is a new project workspace, then the subject content may be the first content classified under the new workspace.

Referring still to FIG. 1, after the proposed project workspace classification is recommended to the user via the text box or field 115, the user may accept the recommended classification by selecting the “Yes” button 125, may reject the classification by selecting the “No” button 130, or the user may enter a proposed new classification in the text box or field 120, followed by a selection of the “Accept New Classification” button 135. If the user accepts the classification, then the subject content will be classified as recommended by the automatic content classification system. If the user rejects the proposed classification, then the subject content may be stored, as selected by the user without being classified into any particular project workspace, or alternatively, the automatic content classification system may analyze the content at a subsequent time based on the generation and storage of additional content, and an alternative classification may be suggested. If the user enters a proposed replacement classification, for example, the user enters a classification associated with a different project workspace, then the subject content will be classified according to the project workspace entered by the user, and the automatic classification system may learn from the user's feedback for enhancing future classifications, as described below.

As should be appreciated, the user interface component illustrated in FIG. 1, along with the location of text boxes, fields, headers, selectable buttons and controls, is for purposes of illustration only and is not limiting of the vast number of orientations and displays of the functionality buttons and controls and text fields that may be constructed for generating an acceptable user interface component 100 for receiving user feedback about content classification, including receiving user acceptance, rejection, modification or replacement to/of an initial content classification suggestion, as described herein.

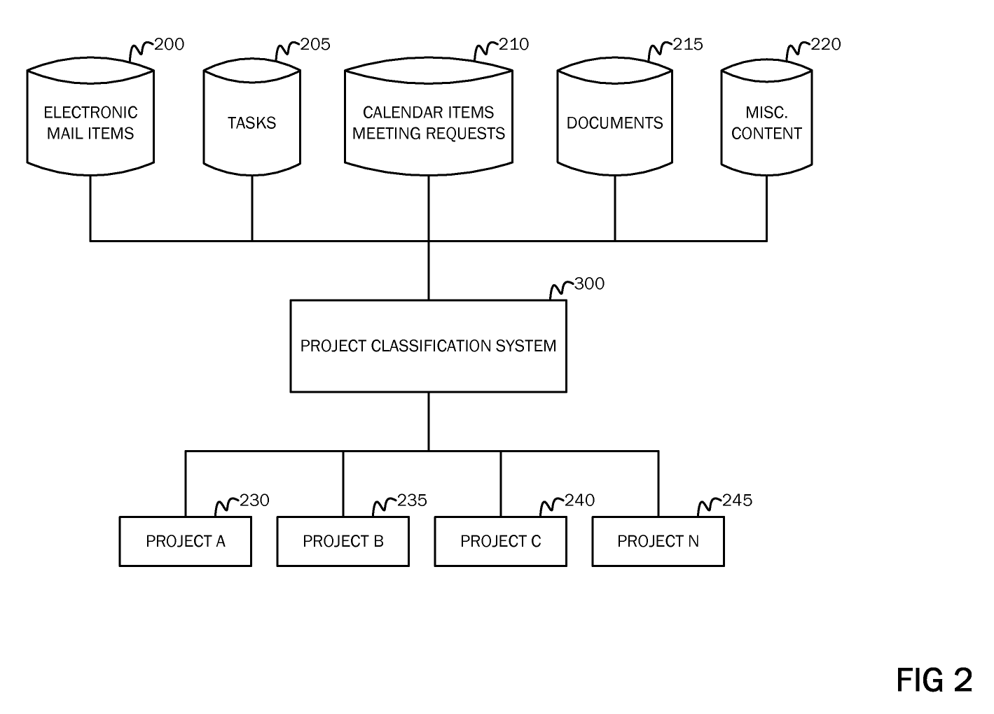

Referring to FIG. 2, relationships between various types of content to the automatic content classification system and to projects to which content may be classified are illustrated. The electronic mail items repository 200 is illustrative or one or more electronic mail items that may be classified into a given project, as described herein. According to embodiments, electronic mail items may be classified upon a user's attempt to transmit an electronic mail item, or when the user receives and opens an electronic mail item. That is, the user interface component 100, described above, may be launched when the user sends or receives an electronic mail item to allow for classification of the electronic mail item according to a particular project.

The tasks repository 205 may include tasks generated and stored by a user or tasks received by the user from other users that are subsequently stored in a task database for the user. When a task item is stored by the user, the task item may be classified into a given project workspace via the user interface component 100, described above. The calendar items and meeting requests repository 210 is illustrative of calendar items, received and sent meeting request items, and the like, and such calendar items may be recommended for a classification according to a given project workspace upon generation, sending, receiving, or accepting.

The documents repository 215 and the miscellaneous content repository 220 are illustrative of any content generated and stored, or received and stored by a user that may be classified into a given project through user feedback, as described herein. The automatic content classification system 300 is operative to classify the content received from the various sources 200-220 and for recommending and causing classification of the various content items into one or more project workspaces 230, 235, 240, 245.

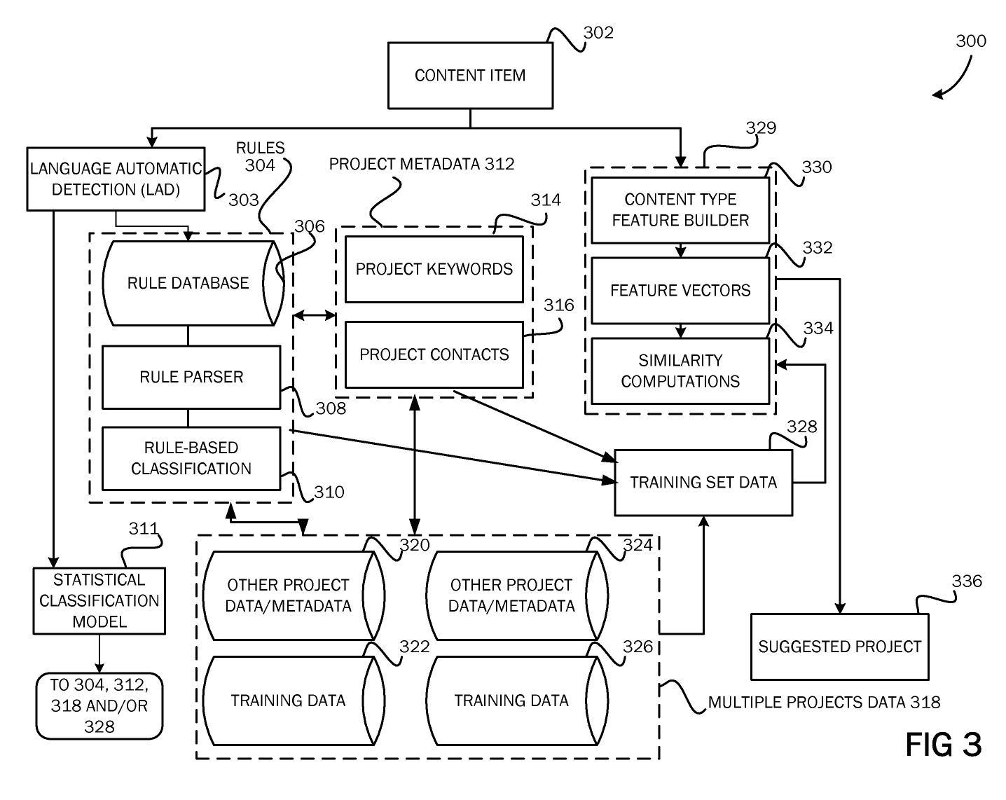

FIG. 3 illustrates a system architecture and process flow associated with automatically classifying electronic content into one or more electronic project workspaces. According to embodiments, the automatic content classification system 300 is operative to propose and cause via user feedback the classification of one or more content items, as described above with respect to FIG. 2, into one or more prescribed project workspaces. For example, if a user is associated with four different project groups, each of which having a dedicated project workspace, each time the user generates and stores a content item, receives or sends a content item, or the like, the automatic content classification system 300 may propose a classification of the content item into one of the user's four different example project workspaces. Alternatively, if the user is not associated with any project workspaces, the automatic classification system 300 may nonetheless propose classification of a new, sent or received content item into an existing project workspace. For example, if the user is a new employee of an organization, his/her new content items may be classified according to existing project workspaces associated with his/her new employer. In addition, if the user generates, sends, receives, or otherwise handles a content item for which no project workspace is related, the automatic classification system 300 may propose a new project workspace from terms or features extracted from the subject content item, and then future content items generated by the user, or by other users may be classified for inclusion in the new project workspace.

Referring still to FIG. 3, according to embodiments, the automatic content classification system 300 operates according to three primary operational components. A first component includes one or more project data stores, for example, the project data stores 230, 235, 240 and 245 illustrated above with respect to FIG. 2. The project data stores contain all of the shared resources of a given project team including documents, meeting information, task information, calendar information, electronic mail items, text messaging items and the like. The project data store for a given project team may serve as a source of training data for the automatic content classification system 300 by providing information to which extracted features from a new content item may be compared for determining which project workspace to recommended inclusion for a new content item. That is, in any given organization, there may be many project data stores associated with different project workspaces, and the automatic content classification system 300 is operative to recommend and cause, after user feedback, the inclusion of a given content item into one of the multiple project data stores. As should be appreciated, a content item may be included into more than one project data store in association with more than one project workspace.

A second major component of the automatic content classification system 300 is the component of classification of a content item into a given project workspace, as described below with reference to FIG. 3. A third major component of the automatic content classification system includes a feedback mechanism, as described above with reference to FIG. 1, whereby a user is allowed an opportunity to accept, reject, or modify a classification recommended for a given content item for improving the ultimate classification of content items into various workspaces.

Referring still to FIG. 3, the components of the automatic content classification system 300 are further illustrated and described. When a content item 302 is received for classification into a given workspace, text, data and metadata contained in and/or associated with the content item are processed for use by the automatic content classification system 300. Received content and metadata are analyzed and formatted as necessary for text processing described below. According to embodiments, the content item processing may be performed by a text parser operative to parse text contained in the received content item and associated metadata for processing the text into one or more text components (e.g., sentences and terms comprising the one or more sentences). For example, if the content item and associated metadata are formatted according to a structured data language, for example, Extensible Markup Language (XML), the content preparation may include parsing the retrieved content item and associated metadata according to the associated structured data language for processing the text as described herein. For another example, the content item and associated metadata may be retrieved from an online source such as an Internet-based chat forum where the retrieved text may be formatted according to a formatting such as Hypertext Markup Language (HTML). According to embodiments, the content preparation may be include formatting the received content item and associated metadata from such a source so that it may be processed for content classification as described herein.

The text included in the content item and associated metadata next may be processed for use classifying the content into a given workspace. A text processing application may be employed whereby the text is broken into one or more text components for determining whether the received/retrieved text may be contain terms that may be used in comparing to other classified content. Breaking the text into the one or more text components may include breaking the text into individual sentences followed by breaking the individual sentences into individual tokens, for example, words, numeric strings, etc.

Such text processing is well known to those skilled in the art and may include breaking text portions into individual sentences and individual tokens according to known parameters. For example, punctuation marks and capitalization contained in a text portion may be utilized for determining the beginning and ending of a sentence. Spaces contained between portions of text may be utilized for determining breaks between individual tokens, for example, individual words, contained in individual sentences. According to one embodiment, content may be tokenized in a way that avoids lexicon size growing too large. For example, if a language allows compounds to be formed by combining two nouns by a hyphen, breaking the compounds before and after hyphen to make it three tokens can avoid the need of adding all possible compounds in a lexicon which may cause a lexicon to grow large enough to cause process performance problems. That is, if compound like “front-wheel” is broken into three tokens, “front”, “−”, “wheel”, then the lexicon only needs to store the three tokens instead of the three tokens plus the compound “front-wheel.” Thus, the lexicon may cover as many words as possible and processing performance improved owing to less unknown words.

In addition, alphanumeric strings following known patterns, for example, five digit numbers associated with zip codes, may be utilized for identifying portions of text. In addition, initially identified sentences or sentence tokens may be passed to one or more recognizer programs for comparing initially identified sentences or tokens against databases of known sentences or tokens for further determining individual sentences or tokens. For example, a word contained in a given sentence may be passed to a database to determine whether the word is a person's name, the name of a city, the name of a company, or whether a particular token is a recognized acronym, trade name, or the like. As should be appreciated, a variety of means may be employed for comparing sentences or tokens of sentences against known, words, or other alphanumeric strings for further identifying those text items.

Referring still to FIG. 3, after a content item has been received and has been processed for classification, as described above, the content item may be classified for inclusion into a given project workspace according to a rules classification system, a project metadata classification system, and a keywords and phrases classification system, or a combination thereof. According to one embodiment, after a content item is received at component/operation 302, the content item may be passed through a language automatic detection (LAD) application at operation 303. At operation 303, the language of the content item is considered before processing the content item for classification. According to an embodiment, the language of the content may be considered because the classification rules, described below, may be different for different languages, and thus, the rules will perform better if a language to which the rules will apply is known. In addition, any text processing, such as breaking content into individual tokens, sentences and/or words, may be language specific. For example, it is possible that a certain language environment may contain multiple languages texts. For example, input texts from users in Canada may contain English and French. The operation of an LAD application may be performed according to any suitable means for determining the language of the content item before processing. For example, metadata associated with the content item may be analyzed to determine keyboard settings for the content item at the time of creation, snippets of the content item may be compared against databases of words associated with various languages, and the like.

According to another embodiment, the received content item may be passed directly to the rules component/operation 304 or statistical classification model 311, described, below without passing the content item first through the LAD at operation 303. As should be appreciated, language identification for a given content item may be obtained through other means, for example, as a metadata item associated with the content item, such that the LAD is not necessary for determining one or more languages associated with the content item.

The content item is next passed to a rules component/operation 304. The rules component/operation 304 is comprised of a rule database 306, a rule parser 308 and a rule-based classification application 310. The rule database is a repository of rules that may be used to classify a given content item based on one or more specific criteria. For example, if the title of the content item contains the same name as a given project name, then a given rule in the rule database 306 may include automatically recommending the content item for the project bearing the same name. A second example rule might include recommending a content item generated by a particular user to a particular project workspace, when the particular user is associated only with that particular workspace and no others. A third example rule might include a rule based on timing associated with a content item. For example, if all content items generated on a certain day of a period, for example, the last day of a fiscal quarter, should be associated with a given project workspace, for example, quarter-end data, then all content items generated on that particular date may be automatically associated with that project workspace.

The rule parser 308 is an application operative to parse the rules contained in the rule database 306 for comparison of those rules to terms extracted from the content item via text processing and content analysis described above. The rule-based classification application 310 is an application operative to apply the aforementioned rules to processed text and metadata associated with the content item for determining whether a rule is met requiring the recommended classification of the content item for inclusion in a given project workspace.

According to an embodiment, in addition to the use of a rule-based classification system, as described above, a statistical term classification model 311 for identifying parts of a content item as belonging to a given classification may be used. For example a statistical model known as part-of-speech tagging or grammatical tagging may be used where components of a text-based content item may be characterized based on a location and contextual association with other components of the text component. Thus, for example, according to part-of-speech tagging (POS), a word normally operating as a noun may be classified as a verb owing to its location between to known nouns and owing to the context of the words. Such a POS system may be used as an alternative to the rule-based system described above, or the two systems may be combined to enhance classification efficiency. As illustrated in FIG. 3, output from the statistical model 311 may be passed to components 304, 312 and 318 for further processing as described herein, or the output from the statistical model 311 may go directly to the training set data component 328 as described below, or output may be passed through a combination of these components as desired for varying levels of classification determination. That is, if a given content item may be adequately classified through analysis via a single classification analysis, for example, statistical classification model, then the output from that analysis may be utilized. On the other hand, a more rigorous analysis may be performed by utilizing all or a combination of the analysis means described herein.

Referring now to project metadata component/operation 312, metadata associated with the content item, for example, content title, content author, content location, date/time of content generation and storage, date/time of content item transmission or receipt, metadata associating the content item with other content items, metadata associating the content item with other project workspaces, and the like may be utilized for recommending classification of a given content item into a given project workspace. The project keywords component 314 and the project contacts component 316 may be utilized for associating metadata, keywords, terms, features and the like extracted from the content item and for associating or comparing those items through contact information or other identifying information associated with one or more project workspaces for recommending classification of a given content item into a particular project workspace. For example, if the content item includes an electronic mail item bearing a sender name, one or more receiver names, a title, and the like that may be matched to similar metadata associated with other electronic mail items previously classified into a particular workspace, that information may be used by the automatic content classification system 300 for recommending inclusion of the example electronic mail item with the particular project workspace.

At multiple projects data component/operation 318, content and metadata extracted from the content items may be utilized by the automatic content classification system 300 for proposing or recommending classification of a given content item into a particular project workspace. According to embodiments, the multiple projects data component/operation 318 is illustrative of an access point to project data/metadata 320, 324, and training data 322, 326 associated with content items previously classified into one or more other project workspaces, for example, the project workspaces 230, 235, 240, 245, illustrated in FIG. 2. That is, the project data/metadata and training data illustrated in component/operation 318 is illustrative of project data/metadata and information associated with the classification of various previous content items to one or more other project workspaces.

For example, a document previously assigned to a given project workspace will have various data comprising the document including text, images, numeric data, and the like that was processed for analysis and classification when that document was previously classified into a given workspace. In addition, during the classification process, training data associated with the classification of that document may have been generated. For example, if a first proposed classification for that document was presented to a user, but the user rejected the proposed classification and proposed an alternate classification via the user interface 100, illustrated above in FIG. 1, the automatic classification system 300 will have stored information indicating that data and metadata associated with the content item was more appropriately associated with the classification proposed by the user. That resulting training data may then be used by the automatic classification system 300 in association with other project data and metadata for subsequently classifying a new content item by comparing data associated with the new content item with the project data and training data associated with content items stored in other project workspaces.

The training set data component/operation 328 is illustrative of training data for the automatic classification system 300 in association with the content item presently being analyzed and classified. That is, information from one or more analyses/components, for example, the rules component 304, a POS tagging system, the project metadata component 312, the multiple projects data 318, or combinations thereof, may be assembled for use in causing the system 300 to associate the present content item with a given project workspace. That is, each of these systems may be used independently for classifying a piece of content, or combinations of each of these systems may be used for optimizing the classification process, described herein. For example, if out of every ten electronic mails from a particular sender, eight of the electronic mails are ultimately classified into a particular project workspace, then if the current content item is an electronic mail from the same sender, then the 80% chance that the electronic mail may be classified into that same project workspace may be utilized along with other data for assisting in the classification.

After training set data is generated for the current content item, the system proceeds to classification component/operation 329. The content type feature builder component 334 is utilized for initially classifying the information about the content according to a particular content type, for example, a word processing document, a spreadsheet document, an electronic mail item, a text message item, a meeting notice, a task item, and the like. The feature vectors component 332 is utilized for organizing the information extracted from the content item for comparing the information against similar information contained in other content items previously classified into one or more other project workspaces. For example, if the content type is associated with an electronic mail item, then feature vectors associated with the electronic mail item may include sending party, receiving party, subject line, transmission type, such as electronic mail versus text messaging, and the like.

After feature vectors are developed for the information extracted from or obtained in association with the current content item, similarity comparisons and computations component/operation 330 compares the information assembled for the content item with similar information contained in or associated with content items previously classified into one or more other project workspaces. Once the current content item is found to be similar to content items previously classified into one or more other project workspaces, the one or more other project workspaces may be proposed to a user as a suggested project 336.

As described above, the suggested project 336 may be proposed to the user via the user interface component 100 illustrated and described above with reference to FIG. 1. As described above, once the suggested project classification is presented to the user via the user interface 100, feedback from the user may be utilized by the system 300 for finalizing the classification of the current content item or for replacing the suggested classification with a classification provided by the user. In addition, feedback from the user may be utilized for updating training information for the system 300. For example, if a user accepts the proposed content classification, the user's acceptance may be utilized by the system 300 for verifying its methodology and the feature vector construction with respect to the current content item and future similar content items.

If the user rejects the proposed classification, then the system 300 may utilize the rejection to cause the system 300 to analyze the information again and to propose a different classification, for example, a second classification that ranks slightly lower than the first proposed classification. If the user proposes a new project workspace classification for the content item, then the system may parse the information contained in content items associated with the project workspace proposed by the user to compare with data extracted from and obtained in association with the current content item for enhancing its ability to make project workspace suggestions on future similar content items.

Referring still to FIG. 3, when a new content item is received, before processing the content item through the rules component/operation 304, the project metadata component/operation 312, and/or the multiple projects data component/operation 318, the content may be passed directly to the classification component/operation 329 to determine whether the content item is so similar to content items previously classified into a given project workspace that additional analysis is not required. For example, an electronic mail item that is a simple response to a previous electronic mail item already classified under a particular project workspace may be passed directly to the classification component 329 for similarity analysis and for project classification recommendation. That is, if information comprising the example electronic mail content item, such as sender name, recipient name, date/time of transmission, subject line, etc., indicate that the new content item is so similar to previous content items already classified under a given project workspace, the example electronic mail content item may be proposed for classification into that project workspace.

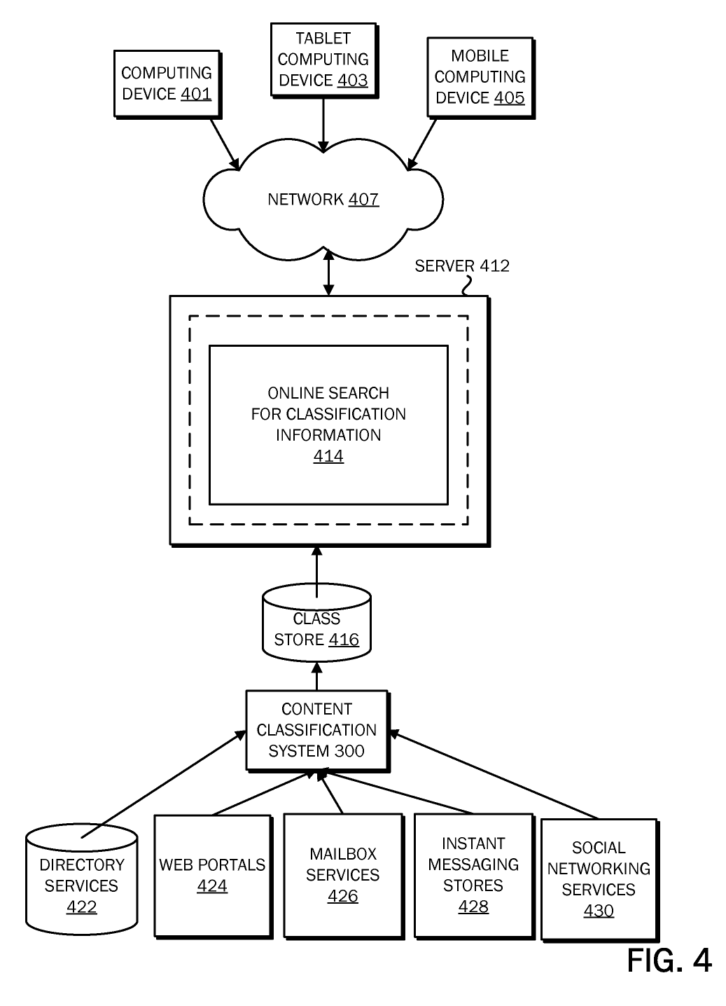

FIG. 4 illustrates a system architecture for providing content classification to various client devices after generation as described above. As described previously, an automatic content classification system 300 may be utilized for classifying content items into one or more project workspaces received via a variety of communication channels and stores. Information and features helpful in classifying content items into one or more project workspaces may also be stored in different communication channels or other storage types. For example, received content items and associated metadata or feature information may be stored using directory services 422, web portals 424, mailbox services 426, instant messaging stores 428 and social networking sites 430. The content classification system 300 may use any of these types of systems or the like to store content item classifications and associated metadata in a classification store 416. A server 412 may provide content item classifications to various clients. As one example, server 412 may be a web server providing content classifications over the web. Server 412 may provide online content classifications over the web to clients through a network 407. Examples of clients that may obtain content classifications include computing device 401, which may include any general purpose personal computer, a tablet computing device 403 and/or mobile computing device 405 which may include smart phones. Any of these devices may obtain content classifications from the content classification store 416.

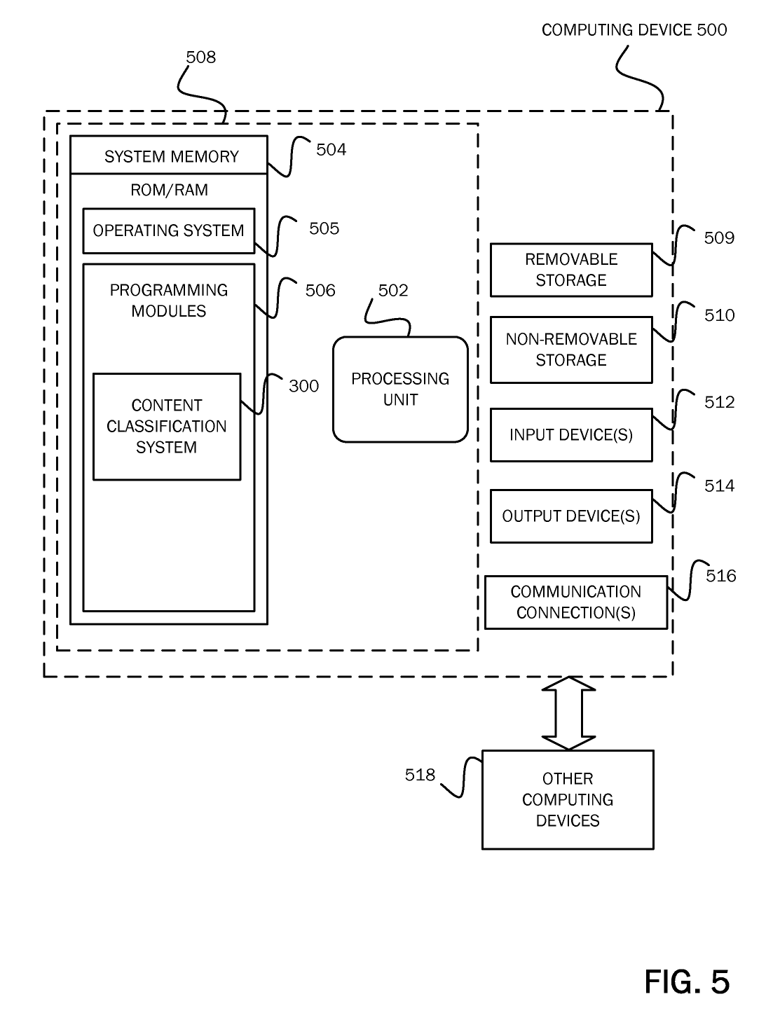

As described above, embodiments of the invention may be implemented via local and remote computing and data storage systems, including the systems illustrated and described with reference to FIGS. 1-4. Consistent with embodiments of the invention, the aforementioned memory storage and processing unit may be implemented in a computing device, such as computing device 500 of FIG. 5. According to embodiments, the computing device may be in the form of a personal computer, server computer, handheld computer, smart phone, tablet or slate device, or any other device capable of containing and operating the computing components and functionality described herein. In addition, the computing device components described below may operate as a computing system printed on a programmable chip. Any suitable combination of hardware, software, or firmware may be used to implement the memory storage and processing unit. For example, the memory storage and processing unit may be implemented with computing device 500 or any other computing devices 518, in combination with computing device 500, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention.

With reference to FIG. 5, a system consistent with embodiments of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include the project content classification system 300 having sufficient computer-executable instructions, which when executed, performs functionalities as described herein. Operating system 505, for example, may be suitable for controlling computing device 500's operation. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computing device 500 may also contain a communication connection 516 that may allow device 500 to communicate with other computing devices 518, such as over a network in a distributed computing environment, for example, an intranet or the Internet. Communication connection 516 is one example of communication media.

As stated above, a number of program modules and data files may be stored in system memory 504, including operating system 505. While executing on processing unit 502, programming modules 506 and may include the automatic content classification system 300 which may be program modules containing sufficient computer-executable instructions, which when executed, performs functionalities as described herein. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

1. A method of automatically classifying electronic content into a project workspace, comprising:
receiving a content item;
processing the received content item into text components and metadata items for use in classifying the content item according to a given project workspace;
parsing one or more rules for classifying a given content item according to a particular project workspace;
classifying the received content item into the particular project workspace; and
displaying the classification of the received content item to a user of the received content item.

2. The method of claim 1, prior to parsing one or more rules for classifying a given content item according to a particular project workspace, determining a language associated with the received content item.

3. The method of claim 1, wherein classifying the received content item into the particular project workspace includes classifying the received content item into the particular project workspace if the one or more text components or metadata items for the received content item comply with one or more rules for classifying the received content item.

4. The method of claim 1, wherein classifying the received content item into the particular project workspace includes determining whether one or more of the text components may be classified based on a statistical classification model.

5. The method of claim 4, further comprising storing the received content item, the text components and metadata items for the received content item with other content items and text components and metadata items associated with the other content items classified into the particular project workspace.

6. The method of claim 1, wherein displaying the classification of the received content item to a user of the received content item includes displaying the classification of the received content item to a user of the received content item for receiving user feedback on the classification of the received content item into the particular project workspace and further includes displaying the classification of the received content item to a user of the received content item as a candidate classification of the received content item for user acceptance of the candidate classification of the received content item as a correct classification of the received item into the particular project workspace.

7. The method of claim 6, wherein if the user accepts the candidate classification of the received content item as a correct classification of the received item into the particular project workspace, classifying the received content item into the particular project workspace.

8. The method of claim 7, wherein if the user does not accept the candidate classification of the received content item as a correct classification of the received content item into the particular project workspace, receiving a replacement classification of the received content item from the user and generating the replacement classification as a corrected classification for the received content item.

9. The method of claim 1, prior to displaying the classification of the received content item to a user of the received content item for receiving user feedback on the classification of the received content item into the particular project workspace, further comprising determining whether one or more metadata items for the received content item match one or more metadata items associated with one or more content items classified into the particular project workspace.

10. The method of claim 1, prior to displaying the classification of the received content item to a user of the received content item for receiving user feedback on the classification of the received content item into the particular project workspace, further comprising determining whether one or more text components contained in the received content item match one or more content items classified into the particular project workspace.

11. A system for automatically classifying electronic content into a project workspace, comprising:
a project data store operative to contain a plurality of data items associated with one or more content items classified into a particular project workspace;
a content classification system operative to classify a received content item into the particular workspace based on a relationship between data associated with the received content item and one or more of the plurality of data items associated with the one or more content items classified into the particular project workspace; and
a feedback system operative to receive user verification that a classification of the received content item into the particular project workspace is a correct classification.

12. The system of claim 11, wherein the content classification system is further operative to classify a received content item into the particular workspace based on a determination that one or more text components or metadata items comprising the received content item comply with one or more rules for classifying the received content item into a particular project workspace, where the complied with one or more of the rules is met by one or more other content items currently classified into the particular project workspace.

13. The system of claim 11, wherein the content classification system is further operative to classify a received content item into the particular workspace based on a determination that one or more metadata items for the received content item match one or more metadata items associated with one or more content items classified into the particular project workspace.

14. The system of claim 11, wherein the content classification system is further operative to classify a received content item into the particular workspace based on a determination that one or more text components contained in the received content item match one or more content items classified into the particular project workspace.

15. The system of claim 11, wherein the a feedback system is further operative to display the classification of the received content item to a user of the received content item as a candidate classification of the received content item for user acceptance of the candidate classification of the received content item as a correct classification of the received item into the particular project workspace.

16. The system of claim 15, wherein the feedback system is further operative to classify the received content item into the particular project workspace if the user accepts the candidate classification of the received content item as a correct classification of the received content item into the particular project workspace.

17. The system of claim 16, wherein the feedback system is further operative to receive a replacement classification of the received content item from the user and generate the replacement classification as a corrected classification for the received content item if the user does not accept the candidate classification of the received content item as a correct classification of the received content item into the particular project workspace.

18. A computer readable storage medium containing computer executable instructions which when executed by a computer perform a method of automatically classifying electronic content into a project workspace, comprising:
receiving a content item;
processing the received content item into text components and metadata items for use in classifying the content item according to a given project workspace;
if the one or more classified text components match one or more corresponding text components currently classified into the particular project workspace, classifying the received content item into the particular project workspace; and
displaying the classification of the received content item to a user of the received content item.

19. The computer readable storage medium of claim 18, prior to determining whether one or more of the text components may be classified into a particular project workspace based on a statistical part-of-speech tagging model, determining a language associated with the received content item.

20. The computer readable storage medium of claim 18, wherein displaying the classification of the received content item to a user of the received content item includes displaying the classification of the received content item to a user of the received content item for receiving user feedback on the classification of the received content item into the particular project workspace and further includes displaying the classification of the received content item to a user of the received content item as a candidate classification of the received content item for user acceptance of the candidate classification of the received content item as a correct classification of the received item into the particular project workspace.
